(19) United States
(12) Patent Application Publication
(10) Pub. No.: US 2005/0238762 A1
(43) Pub. Date: Oct. 27, 2005

(54) Anti-dripping provision for ice cream cones and similar items

(76) Inventor: Elias De Los Santos, Las Pinas City (PH)

Correspondence Address: RICHARD E. NOVAK, CHESTNUT HILL PROFESSIONAL CENTER, 157 ENGLE STREET, ENGLEWOOD, NJ, 07631, US

(21) Appl. No.: 11/018,584

(22) Filed: Dec. 21, 2004

(30) Foreign Application Priority Data
Apr. 21, 2004 (PH) 22004000165

(51) Int. Cl. A23G 3/00

(52) U.S. Cl. 426/90

(57) ABSTRACT

An ice cream cone with anti-dripping feature which collects liquid from ice cream as it melts, includes an open upper end for receiving the ice cream and an annular flange having a plurality of apertures extending around the periphery of the cone below the lip portion. Melted ice cream which drips down the outside of the ice cream cone is collected in the annular flange and passes through the apertures, collecting inside the ice cream cone. The annular flange with a plurality of apertures described herein also functions as an anti-dripping feature for paint cans and other similar containers holding thick liquids.

### RELATED PATENT APPLICATIONS

This application claims foreign priority based upon Application No. 2200400165 filed in the Philippines on Apr. 21, 2004.

### BACKGROUND OF THE INVENTION

The present invention relates to anti-dripping ice cream cones, and in particular to ice cream cones having an anti-dripping feature which returns melted ice cream to the inside of the cone to prevent waste and mess.

A common problem encountered when eating ice cream cones is that the ice cream melts faster than it is eaten. This problem is compounded because ice cream is more often eaten when the weather is warm. The melting ice cream drips down the outside of the cone, frequently coming into contact with the consumer's hand and clothes.

A commonly employed solution is to wrap a tissue or napkin around the ice cream cone to catch dripping ice cream. This is only a partial solution, however, as the tissue or napkin tends to become saturated and messy. In addition, such absorbed ice cream is simply thrown away and wasted. This detracts from the pleasant experience of eating ice cream and may also present the potential for spreading germs, viruses and bacteria.

The present invention may be adapted for use in the case of other items that present the same problem, such as containers for paint and other thick liquids.

### SUMMARY OF THE INVENTION

It is therefore an object of the present invention to provide an anti-dripping feature for ice cream cones similar items, which catches the drip and returns it to the cone, protecting the consumer from melting ice cream or other thick liquids dripping onto the hands, clothing, floors or the inside of a motor vehicle.

It is a further object to provide an anti-dripping feature as above which eliminates the use of tissues or napkins, containers and the like, avoiding the mess caused by dripping ice cream.

It is a further object to provide an anti-dripping feature as above which minimizes or eliminates dripping ice cream, thus allowing melted ice cream to be eaten and not wasted.

These and other features of the invention can be further understood by reference to the following drawings.

### BRIEF DESCRIPTION OF THE DRAWINGS

FIG. 1 is a perspective view of the anti-dripping feature.

FIG. 2 is a sectional view take along line 2-2 of FIG. 1.

### DETAILED DESCRIPTION OF THE INVENTION

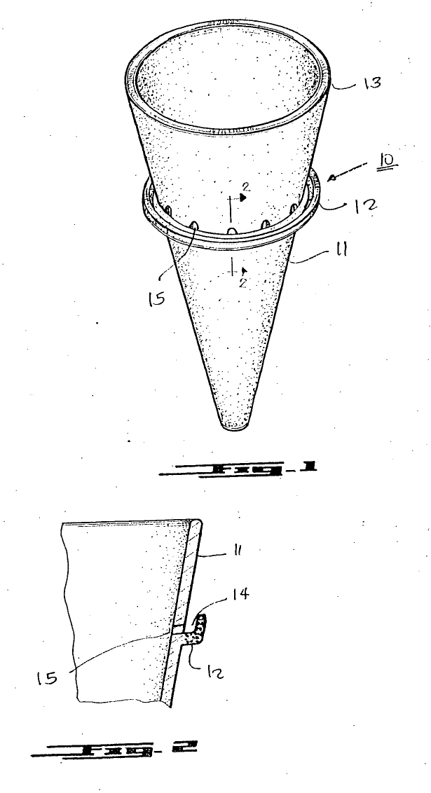

During the course of this description like numerals will be used to identify like elements according to the different figures which illustrate the invention. One embodiment of the present invention is shown in FIGS. 1 and 2. An ice cream cone with anti-dripping feature is designated generally by the numeral 10.

Ice cream cone with anti-dripping feature 10 includes an ice cream cone 11 and an annular flange 12 extending entirely around the periphery of the ice cream cone 11, below the lip portion 13 of the ice cream cone 11.

The annular flange 12 has a channel 14, which has a plurality of apertures 15 in communication with the interior section of ice cream cone 11. When ice cream placed in the opening formed by the lip portion 13 of the ice cream cone 11, begins to drip, dripping ice cream is caught by annular flange 12 and returned to the interior of the ice cream cone 11.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

1. An ice cream cone with anti-drip feature comprising an edible ice cream cone having an open top for receiving and retaining ice cream, said open top having a lip running completely around the periphery of the open top, and said ice cream cone further having an annular flange running completely around the periphery of said ice cream cone, below said lip, said annular flange having a plurality of apertures in communication with the interior of said ice cream cone, and said annular flange extending around the periphery of said ice cream cone.

2. A device according to claim 1, wherein the ice cream cone is cone-shaped.

3. A device according to claim 1, wherein the ice cream cone has a flat base and is frusto-conical.

4. A device according to claim 1, wherein the top receiving potion of said ice cream cone comprises a peripheral ring attached to the interior wall of said ice cream cone, and includes an internal disk attached to said peripheral ring having an open top surface for supporting said ice cream, and a bottom surface, and a centrally located aperture therein to allow melting ice cream to drain therethrough.

5. A device according to claim 4, wherein the draining means comprises a plurality of apertures located around said internal disk to allow melting ice cream to drain therethrough.
